(19) United States
(12) Patent Application Publication
(10) Pub. No.: US 2025/0348812 A1
(43) Pub. Date: Nov. 13, 2025

(54) INFORMATION PROVIDING SYSTEM AND INFORMATION PROVIDING METHOD

(71) Applicant: TOYOTA JIDOSHA KABUSHIKI KAISHA, Toyota-shi (JP)

(72) Inventors: Satoshi TOYOSHIMA, Toyota-shi (JP); Shiro ODA, Anjo-shi (JP); Takeshi MATSUI, Nisshin-shi (JP)

(73) Assignee: TOYOTA JIDOSHA KABUSHIKI KAISHA, Toyota-shi (JP)

(21) Appl. No.: 19/010,600

(22) Filed: Jan. 6, 2025

(30) Foreign Application Priority Data
May 8, 2024 (JP) 2024-075739

(51) Int. Cl. G06Q 10/0631

(52) U.S. Cl. CPC G06Q 10/06315; G06Q 10/06311

(57) ABSTRACT

The information providing system according to the present disclosure inputs input information including information on a plurality of robot accessory units that enable a mobile robot to execute a plurality of different services by being used in combination with a mobile robot that moves autonomously, information on a time period in which the mobile robot operates, and information on a type of a required service. On the basis of the input information, the information providing system performs a calculation process of calculating resource information, which is information related to a resource amount of the mobile robot and the plurality of robot accessory units required for the service, and outputs a result calculated in the calculation process.

### CROSS-REFERENCE TO RELATED APPLICATION

This application claims priority to Japanese Patent Application No. 2024-075739 filed on May 8, 2024, incorporated herein by reference in its entirety.

### BACKGROUND

### 1. Technical Field

The present disclosure relates to an information providing system and an information providing method.

### 2. Description of Related Art

WO 2023/86665 discloses an autonomous mobile robot that pulls a wheeled cart.

### SUMMARY

A technique that enables a user to quantitatively know necessary robot-related resources in accordance with a task time and shift has been desired. Note that the technology described in WO 2023/86665 is not a technology capable of solving this problem.

An information providing system according to the present disclosure is an information providing system that provides information about an autonomous mobile robot and is configured to

input input information including information regarding a plurality of robot accessory units that enable the autonomous mobile robot to execute a plurality of different services by being used in combination with the autonomous mobile robot, information regarding a time period in which the autonomous mobile robot operates, and information regarding a type of a required service,
perform calculation processing of calculating resource information that is information regarding an amount of resources for the autonomous mobile robot and the plurality of robot accessory units required for a service based on the input information, and
output a result of calculation in the calculation processing.
The system may perform the calculation using a machine learning model, for example.

An information providing method according to the present disclosure is an information providing method by which a computer provides information about an autonomous mobile robot, the method including:

inputting input information including information regarding a plurality of robot accessory units that enable the autonomous mobile robot to execute a plurality of different services by being used in combination with the autonomous mobile robot, information regarding a time period in which the autonomous mobile robot operates, and information regarding a type of a required service,
performing calculation processing of calculating resource information that is information regarding an amount of resources for the autonomous mobile robot and the plurality of robot accessory units required for a service based on the input information, and
outputting a result of calculation in the calculation processing.
The computer may perform the calculation using a machine learning model, for example.

According to the present disclosure, it is possible to provide an information providing system and an information providing method enabling a user to quantitatively know necessary robot-related resources in accordance with a task time and a shift.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an overall configuration of a management system including an information providing system;

FIG. 2 is a block diagram illustrating a control system of the management system of FIG. 1;

FIG. 3 is a side view schematically showing a configuration before and after connection of the cleaning unit of FIG. 1;

FIG. 4 is a diagram illustrating an example of information input and output by the management system of FIG. 1;

FIG. 5 is a diagram illustrating an example of schedule information calculated by the management system of FIG. 1; and

FIG. 6 is a flowchart illustrating an information providing method according to the present embodiment.

### DETAILED DESCRIPTION OF EMBODIMENTS

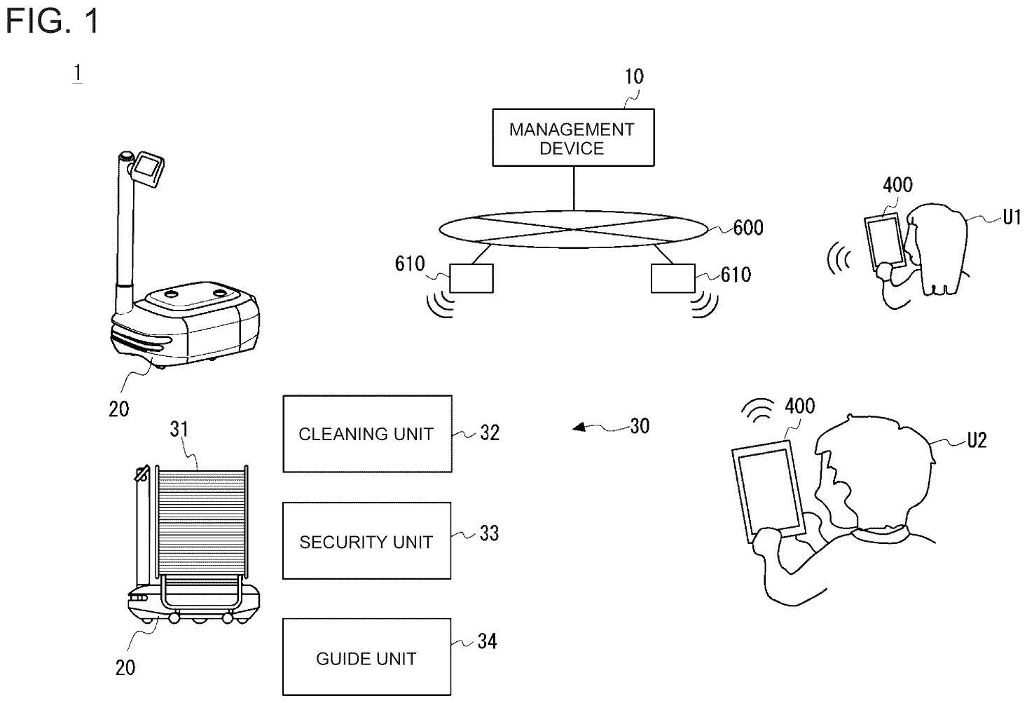

Hereinafter, the present disclosure will be described through embodiments of the disclosure, but the disclosure according to the claims is not limited to the following embodiments. Moreover, all of the configurations described in the embodiments are not necessarily indispensable as means for solving the issue. The information providing system according to the present embodiment is a system that provides information about an autonomous mobile robot. This information providing system can be incorporated in a management system that manages the operation of an autonomous mobile robot capable of executing a plurality of services (also referred to as tasks). As illustrated in FIG. 1, the management system 1 includes one or more mobile robots 20, a management device 10, one or more accessory units 30, a network 600, a communication unit 610, and a user terminal 400. The management system 1 manages the mobile robot 20 and the accessory unit 30. The accessory unit 30 is a robot accessory unit used in combination with the mobile robot 20 to execute each service. For example, the accessory unit 30 is a transport unit 31 exemplified by a wagon that can be mounted on the mobile robot 20 and can accommodate articles, a cleaning unit 32, a security unit 33, and a guide unit 34 that can be mechanically connected to the mobile robot 20. Of course, the accessory unit 30 is not limited thereto. For example, a transfer robot including a wagon that can run with the mobile robot 20 and can accommodate an article, a cleaning robot and a security robot that can run with the mobile robot 20, and other service units may be managed by the management system 1. Hereinafter, an example in which the four types of accessory units 30 are managed will be described, but one or more of the four types may not be managed.

The mobile robot 20 is an autonomous mobile robot and executes a plurality of services such as transportation, cleaning, security, and guidance. The mobile robot 20 autonomously moves a medical welfare facility such as a hospital, a rehabilitation center, a nursing facility, or an elderly residential facility, or a commercial facility such as a shopping mall. The mobile robot 20 includes wheels, a chassis, a motor, a sensor, a battery, a controller, and the like. The mobile robot 20 selectively attaches any one of the units 31 to 34 in accordance with a service to be executed. The mobile robot 20 may be capable of mounting two or more accessory units 30 at the same time. The mobile robot 20 is configured to mount the accessory unit 30 only by its own operation, or configured to assist a user or the like in wearing.

The transport unit 31 is an accessory unit 30 for transporting a conveyed object. For example, the transport unit 31 is a wagon or a cart with wheels, and a conveyed object can be mounted in the wagon or cart. The carriage portion of the mobile robot 20 serves as a stage on which a wagon or the like is mounted. The transport unit 31 may be used for serving a table at a restaurant, a medical welfare facility, or the like, transporting a part at a factory, transporting a sample at a hospital, transporting a linen at a hotel, or the like. The cleaning unit 32 is an accessory unit 30 for cleaning a facility. The cleaning unit 32 includes a cleaner that sucks dust and the like. Alternatively, the cleaning unit 32 includes a pad, a mop, or the like for wiping the floor. The mobile robot 20 can execute the cleaning service by mounting the cleaning unit 32, and the floor surface is cleaned when the mobile robot 20 moves in this state. In addition, the cleaning unit 32 may be a robot cleaner capable of remote control by wireless communication from the mobile robot 20.

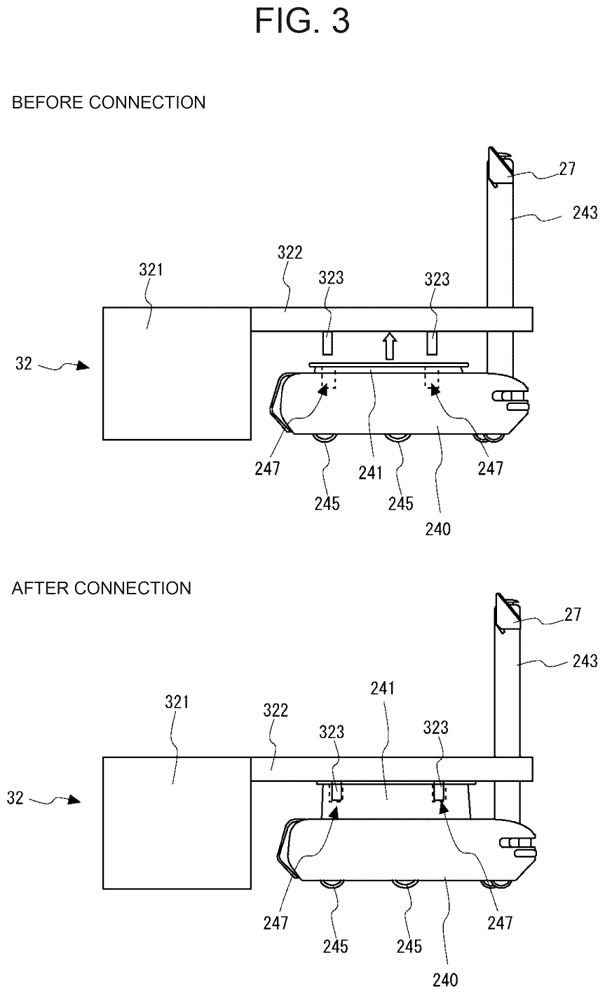

The security unit 33 is an accessory unit 30 for securing a facility, and includes various sensors for detecting an intruder or an abnormality, for example. The various sensors include, for example, a camera, an infrared camera, a ranging sensor, an optical sensor, a thermal sensor, and a smoke sensor. The security unit 33 may include an illumination device that illuminates an intruder or an abnormal portion, an alarm function that notifies the intruder when an abnormality is detected, and the like. The guide unit 34 is an accessory unit 30 for guiding the facility. For example, the guide unit 34 guides the visitor of the facility a route to the destination or the like. The mobile robot 20 moves to a destination in order to guide a visitor. The guide unit 34 includes an input device for a visitor to input a destination, such as a touch panel, a button, a microphone for voice input, or the like. The guide unit 34 may include a display device for displaying a route and a speaker for outputting a voice of the route. Guide unit 34 may be a device that attaches to a support 243 of FIG. 3 that is extended from the body of mobile robot 20.

As described above, the accessory unit 30 is used in combination with the mobile robot 20, so that the mobile robot 20 can execute a plurality of different services. The available accessory unit 30 and the unavailable accessory unit 30 may be set according to the mobile robot 20. In addition, a plurality of accessory units 30 for one service may be provided. The management system 1 may be provided with two or more transport units 31, for example. In this case, the two mobile robots 20 can simultaneously execute the transport service using the transport unit 31. Further, a plurality of types of accessory units 30 may be prepared for one service. For example, the shape and size of the transport unit 31 may be different depending on the contents of the conveyed material.

The user U1 or the user U2 can use the user terminal 400 to make a service request such as a conveyance request for a conveyed object. For example, the user terminal 400 is a tablet computer, a smartphone, or an installation-type computer that can communicate wirelessly or wirelessly.

The mobile robot 20 and the user terminal 400 are connected to the management device 10 via the network 600 connected via the communication unit 610. The network 600 is a wired or wireless local area network (LAN) or wide area network (WAN). Further, the management device 10 is connected to the network 600 by wire or wirelessly. The communication unit 610 is, for example, a wireless LAN unit installed in each environment. The management device 10 is a server connected to each device, and collects data from each device. The management device 10 is not limited to a physically single apparatus, and may include a plurality of apparatuses that perform distributed processing, or may be distributed and arranged in an edge device such as the mobile robot 20. In operation, the user terminal 400 and the mobile robot 20 may transmit and receive signals without passing through the management device 10.

It is assumed that a plurality of mobile robots 20 are used in a facility. The management device 10 assigns a service to each mobile robot 20. Each of the mobile robots 20 is equipped with an accessory unit 30 corresponding to the assigned service, and executes the service. The service executed by the mobile robot 20 may be entered by a user U1 or a user U2, or may be scheduled in advance. For example, a user U1 or the like operates the user terminal 400 to input the type of service to be executed, thereby making a service request. A user U1 or the like may enter an area, a time-zone, or the like in which the service is executed.

In such an overall configuration, each element of the management system 1 can be distributed among the mobile robot 20, the user terminal 400, and the management device 10 to construct the management system 1 as a whole.

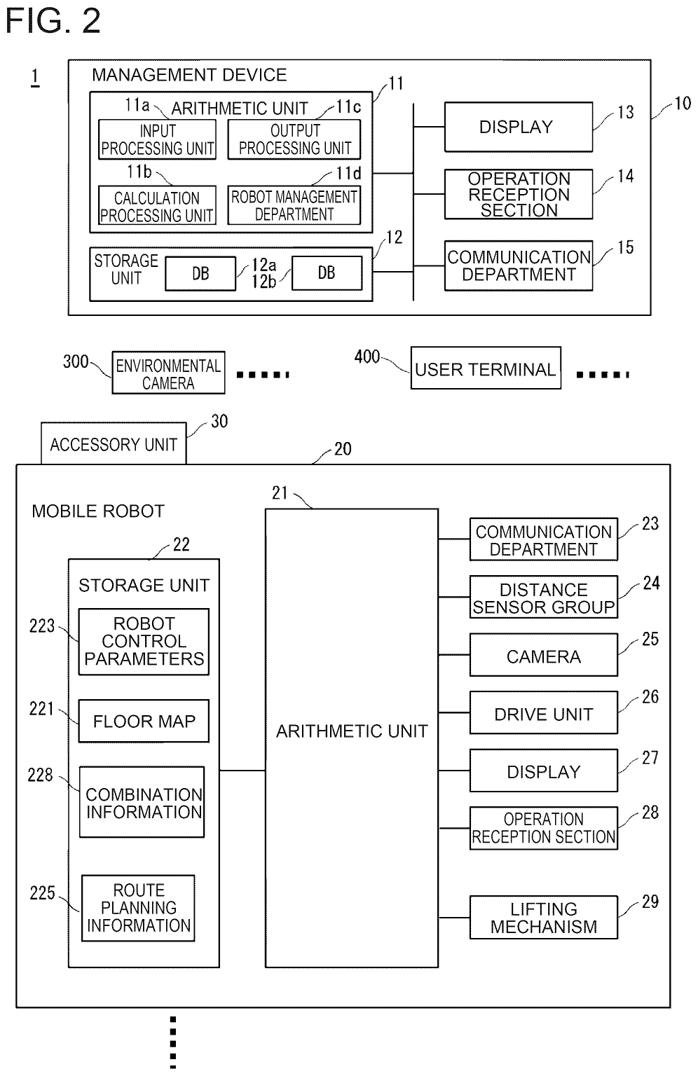

As illustrated in FIG. 2, the management system 1 includes a management device (higher-level management device) 10, a mobile robot 20, an accessory unit 30, an environment camera 300, and a user terminal 400. The management device 10 includes, for example, an arithmetic processing unit 11, a storage unit 12, a display unit 13, an operation reception unit 14, and a communication unit 15. In FIG. 2, some devices such as the network 600 and the communication unit 610 are omitted.

The arithmetic processing unit 11 may be implemented by a computer including a processor such as a CPU (Central Processing Unit), a working memory, a non-volatile storage device, and the like. The control program executed by the processor is stored in the storage device, and the processor reads the control program into the working memory and executes the read control program, whereby the arithmetic processing unit 11 can perform a function as described later. This storage device can also use the storage unit 12. The arithmetic processing unit 11 may be configured as a dedicated control circuit.

The arithmetic processing unit 11 includes a robot management unit 11d for controlling and managing the mobile robot 20. For example, the robot management unit 11d receives a service request from the user terminal 400 or the like via the communication unit 15. The robot management unit 11d selects one mobile robot 20 and the required accessory unit 30 from the plurality of mobile robots 20. The robot management unit 11d instructs the mobile robot 20 to perform servicing via the communication unit 15 so that the mobile robot 20 operates efficiently.

The arithmetic processing unit 11 includes, for example, an input processing unit 11a, a calculation processing unit 11b, and an output processing unit 11c for providing information about the mobile robot 20. Therefore, the management device 10 may be referred to as an information providing apparatus.

The information providing system according to the present embodiment is not limited to the example used in the operation stage, and may be used before the operation of the autonomous mobile robot, that is, before the introduction of the autonomous mobile robot. When the information providing system is not incorporated in the management system 1, for example, the information providing system may be configured by a device having a configuration excluding the robot management unit 11d in the management device 10, or may be configured by the device and a user terminal. In this case, the user terminal in the information providing system may be a user terminal different from the user terminal 400 used in later operation.

The storage unit 12 includes a storage device such as a memory, a hard disk drive, or an SSD (Solid State Drive). The storage unit 12 stores various types of information, such as databases (DB) 12a, 12b, which will be described later. The communication unit 15 is a communication interface for communicating with the user terminal 400, the mobile robot 20, and the environment camera 300.

The display unit 13 is a display device that displays information. The operation reception unit 14 is an input device such as a keyboard or a pointing device. The display unit 13 and the operation reception unit 14 may be realized by, for example, a touch panel display. In this instance, the display unit 27 displays user interface (UI) images. For example, when the management device 10 is operated from the user terminal 400, the display unit 13 and the operation reception unit 14 may not be provided in the management device 10.

In the management system 1, the mobile robot 20 performs route planning based on the service information. Based on the route plan information created by the mobile robot 20, the mobile robot autonomously moves toward the destination. The mobile robot 20 autonomously moves toward the destination using sensors, floor maps, position information, and the like provided in the mobile robot 20 itself. Of course, a part of the processing of the mobile robot 20 may be performed by the management device 10.

The mobile robot 20 includes, for example, an arithmetic processing unit 21, a storage unit 22, a communication unit 23, a distance sensor group 24, a camera 25, a drive unit 26, a display unit 27, and an operation reception unit 28. The arithmetic processing unit 21 can be implemented as a device having a hardware configuration similar to that of the arithmetic processing unit 11 and capable of executing a control program. The communication unit 23 is a communication interface for communicating with the management device 10, the environment camera 300, or another mobile robot 20. The communication unit 23 communicates with the communication unit 15 and the like of the management device 10 using, for example, a wireless signal. The distance sensor group 24 includes, for example, a proximity sensor, and outputs proximity object distance information indicating a distance to an object or a person existing around the mobile robot 20. The camera 25 captures an image for grasping a situation around the mobile robot 20, for example. The mobile robot 20 may identify a surrounding object based on an image of the camera 25 or the environment camera 300. The environment camera 300 is a camera such as a surveillance camera installed in a plurality of passages, halls, elevators, entrances, and the like in a facility where the mobile robot 20 travels. The management device 10 or the mobile robot 20 can acquire an image of a moving range of the mobile robot 20 from the environment camera 300.

The drive unit 26 includes a motor that drives drive wheels provided in the mobile robot 20. The mobile robot 20 detects its current position and transmits it to the management device 10. The display unit 27 and the operation reception unit 28 are realized by a touch panel display. The display unit 27 displays UI images, and the operation reception unit 28 accepts an operation from the user. The operation reception unit 28 includes various switches provided in the mobile robot 20. The display unit 27 may display information indicating a destination of the mobile robot 20 and a state of the mobile robot 20, and various types of guidance information. The lifting mechanism 29 lifts and lowers a carriage unit for mounting the transport unit 31. The lifting mechanism 29 includes a motor and a lifting stage that is moved up and down by the motor.

The storage unit 22 includes a storage device similar to the storage unit 12, and stores, for example, a floor map 221, robot control parameters 223, combination information 228, and route plan information 225.

The floor map 221 is map information of a facility for moving the mobile robot 20, and may include, for example, position information of a charging facility for charging the mobile robot 20. The floor map 221 may be downloaded from the management device 10, for example.

The route plan information 225 includes route plan information planned by the arithmetic processing unit 21, and may include, for example, information indicating a destination, route information to a destination, service information inputted from a user U1, and the like. The combination information 228 includes information on a plurality of combinations of the mobile robot 20 and the accessory unit 30 that are connectable to each other. The combination information 228 includes, for example, as a connection method between the mobile robot 20 and the accessory unit 30, information indicating any one of a connection by an elevating operation, a connection by a connection operation, and a connection by a wireless signal.

In the connection by the elevating operation, the mobile robot 20 operates the elevating mechanism to mount the accessory unit 30. Specifically, when the mobile robot 20 raises the elevating stage by the lifting mechanism 29 in a state where the elevating stage is directly below the transport unit 31, the transport unit 31 is mounted on the mobile robot 20 as shown in FIG. 1. In addition, as schematically illustrated in FIG. 3, the cleaning unit 32 may be connected to the mobile robot 20 by an elevating operation, as a configuration before and after connection of the cleaning unit 32. The cleaning unit 32 includes a vacuum cleaner 321, a support portion 322, and a fixing pin 323. The vacuum cleaner 321 is connected to the support portion 322, and a fixing pin 323 is provided below the support portion 322. The fixing pin 323 is a convex portion protruding to the lower side of the support portion 322. The vacuum cleaner 321 may be configured to rotate a mop attached to suction or a lower portion of the mop while rotating, for example, along a vertical axis.

The mobile robot 20 includes a cart 240 provided with wheels 245 and an elevating stage 241, and a display unit 27. A recess 247 into which the fixing pin 323 is inserted is provided on the upper surface of the elevating stage 241. The recess 247 is provided at a position corresponding to the fixing pin 323. At an end portion of the cart 240, a support 243 is provided which extends upward from the cart 240 and on which a touch panel display serving as a display unit 27 or the like is installed. The cleaning unit 32 is connected to the mobile robot 20 by the mobile robot 20 moving to the lower side of the support portion 322, more specifically, the cart 240 moving directly under the support portion 322, raising the elevating stage 241, and inserting the fixing pin 323 into the recess 247. When the mobile robot 20 runs to push or pull the cleaning unit 32, a cleaning service is performed. The transport unit 31 shown in FIG. 1 may also be mounted on the mobile robot 20 with a configuration similar to that of the cleaning unit 32.

In the connection by the coupling operation, for example, a coupling mechanism for coupling to one or both of the mobile robot 20 and the accessory unit 30 is provided. The coupling mechanism is, for example, a hook mechanism, a locking mechanism, an engagement mechanism, a projection, a pin, a traction arm, a hole, a guide mechanism, or a joint mechanism. Then, the mobile robot 20 travels and approaches the accessory unit 30, so that the mobile robot 20 and the accessory unit 30 are connected. A configuration may be adopted in which a user or the like assists in the connection operation.

In the connection by the wireless signal, the mobile robot 20 transmits the wireless signal by, for example, Bluetooth (registered trademark) or the like to the accessory unit 30. In this case, for example, the accessory unit 30 is a cleaning unit including a cleaning robot.

The robot control parameters 223 are parameters used for controlling the operation of the mobile robot 20. The robot control parameters 223 include speed information regarding a speed such as a threshold distance for avoiding contact between the mobile robot 20 and a surrounding object, a speed upper limit value, and the like, a height of the elevating mechanism, a turning radius, and the like.

Upon receiving a service request from the user terminal 400 or the management device 10, the arithmetic processing unit 21 identifies one or a plurality of accessory units 30 to be used based on the combination information 228 and generates a control signal for executing the combination. Further, the arithmetic processing unit 21 performs a route plan for executing the service. For example, the arithmetic processing unit 21 searches for a route to the area where the service is performed or a route in the service, obtains a movement route in the floor map 221, and writes the movement route in the storage unit 22 as the route plan information 225. The arithmetic processing unit 21 extracts a movement command from the control signal and the route plan information 225 given from the management device 10, and controls the drive unit 26 to perform a connection with the accessory unit 30, an autonomous movement toward a destination or a waypoint based on the movement command. The arithmetic processing unit 21 may measure the relative position of the mobile robot 20 with respect to the accessory unit 30 from the detection result of the distance sensor group 24, the image of the camera 25 and the environment camera 300, and perform the alignment of the mobile robot 20 with respect to the accessory unit 30.

Next, a function of providing information of the mobile robot 20 in the management device 10 will be described. The input processing unit 11a performs processing of inputting input data. The input information input person can be a merchant who sells the mobile robot 20 or the accessory unit 30, or a user of a facility that is operating the management system 1. This input can be performed while UI images for input are displayed on the display unit 13 from the operation reception unit 14, but can also be performed from the user terminal 400 via the communication unit 15, for example. This input may include text input, touch panel input, choice input, speech input, and input by speech response to artificial intelligence. The input information includes unit information that is information about the plurality of accessory units 30, time period information that is information about a time period in which the mobile robot 20 operates, and type information that is information about a type of a required service. However, the unit information in the input information is stored in advance in the storage unit 12 or the like without being input by the input person, and it is necessary to read the unit information at the time of calculation in the calculation processing unit 11b.

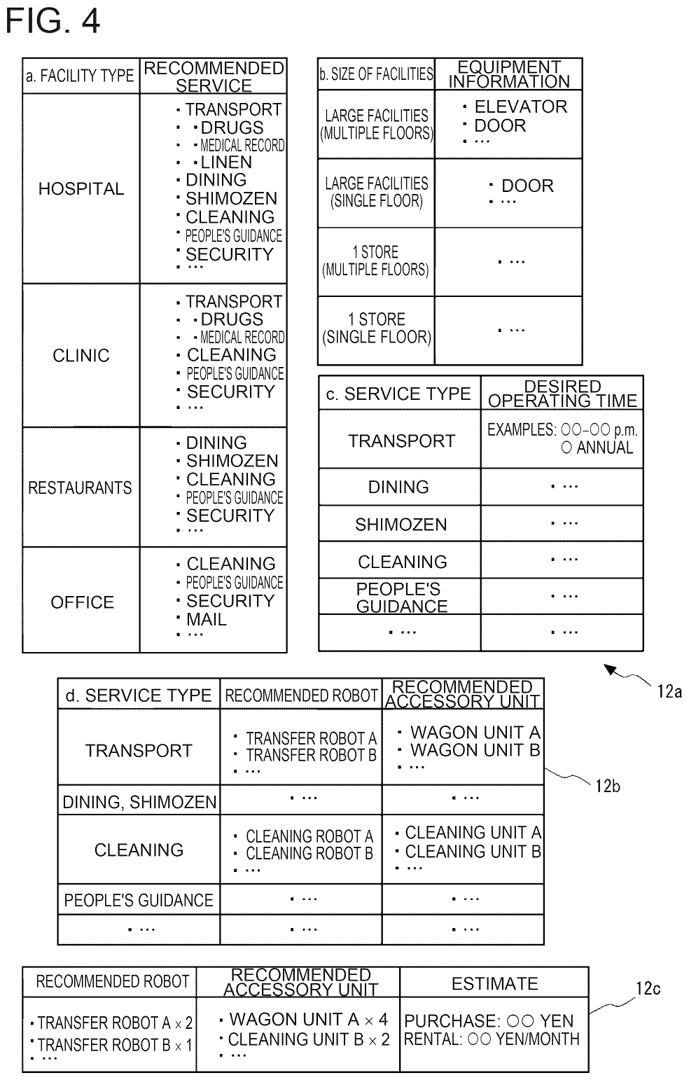

The unit information may be a DB 12b such as the table d shown in FIG. 4, and may include the type of the recommended mobile robot 20 and the recommended accessory unit 30 for each service type. That is, the unit information may include information indicating a service that can be provided by the accessory unit 30 and information indicating the mobile robot 20 to be attached. The different plurality of services may include at least two of transportation, patrol security, and cleaning services. The information indicating the service that the accessory unit 30 can provide may include, for example, the same cleaning unit or information indicating the service for each detailed use so that the cleaning unit A for carpet cleaning, the cleaning unit B for tile cleaning, and the like can be distinguished from each other. The unit information may include information indicating the size of each of the accessory units 30 and each of the mobile robots 20, and the like, and thus the recommended devices may be limited based on the size according to the operation location information and the type information. The unit information may also include information indicating a purchase cost, a rental cost, an operation cost, and the like of each of the mobile robot 20 and the accessory unit 30. At least one of the mobile robot 20 and the accessory unit 30 included in the unit information is not limited to the same manufacturer. In addition, if it is already in the operation stage, the unit information may include information indicating the type and the number of the mobile robots 20 and the accessory units 30 in operation.

The information source of the unit information, that is, the acquisition source may be the storage unit 12. The input processing unit 11a may input the unit information by automatically selecting DB 12b stored in the storage unit 12 at the time of calculating the resource information. Alternatively, the input processing unit 11a may input the unit information by selecting one of DB prepared according to the performance of the mobile robot 20 or the accessory unit 30 by the input person. The acquisition source may be an external device connected to the management device 10. The source may be one or more external Web servers or the like. In this case, the input processing unit 11a searches for the unit information and acquires the search result.

The type information is information related to the type of service desired by the input person to be executed by the mobile robot 20 in the facility. The type information may include information such as a service type, a service execution frequency, a service execution range within a facility, a service execution time, and the like. The execution time may include a time zone, a period, and the like in which the input person desires to operate. The type information may include the information itself related to the accessory unit 30 used for the service.

The time zone information is information related to a time zone in which the mobile robot 20 operates with the accessory unit 30 and provides a service that can be provided by the accessory unit 30, and is, for example, information described as the execution time. For example, the time zone information may be information in which the respective services such as transportation, cleaning, security, and guidance are sorted for each time zone, and may be different information depending on the day of the week or the like.

The time zone information and the type information may be schedule information in which a time zone is stored for each type of service that is required. The schedule information can be calculated based on, for example, type information and operation location information. The operation location information may include information indicating a size such as one or more pieces of information such as a size of an operation location, a site area, a floor area, and the like. The operation location information may include information such as a facility name or an address of a web page of the facility, which specifically indicates a facility to be introduced. When an address is entered, the address can be accessed to obtain information about the facility from the web page. The information indicating the size may simply include information indicating a facility type (a category or a type of a facility) such as a general hospital or a personal clinic, or may include information indicating a size, an area, a rank, or the like of the facility. Information showing size may include information showing, for example, the number of beds, employees, the number of doctors, the number of caregivers, and the number of sick persons.

In the following, the operation location information and the type information are inputted based on DB 12a stored in the storage unit 12. FIG. 4 is a diagram illustrating an example of input information input by the management system 1 and an example of output information output. As shown in FIG. 4, DB 12a includes, for example, tables a, b, c. The input person appropriately selects the operation location information and the type information to be included in the input information based on the information indicated in DB 12a. Of course, the operation location information and the type information may be selected from data other than the facility type, the facility size, and the service type indicated in the tables a, b, c. For example, the operation location information and the type information may include data of a facility type, a facility size, and a service type other than the data indicated in the tables a, b, c as selection targets. Alternatively, at least part of the data indicated in the tables a, b, c may not be included in the selectable operating location information and type information.

In the table a, the operation location information is a facility type for introducing a mobile robot. For example, the input person selects one of a hospital, a clinic, a restaurant, and an office as the facility type. In the example of the table a, for example, when the facility type is a clinic, a service such as transportation, cleaning, guidance of a person, security, and the like is shown in UI images, and the input person can select the facility type while confirming the service, and the selected facility type is input as the operation location information. Alternatively, for example, when the input person selects the clinic as the facility type, the clinic is input as the operation location information, and services such as transportation, cleaning, guidance of a person, and security are input as the type information. As described above, when the selection input of the facility type is performed, the input processing unit 11a can input the facility type as the operation location information, or can further input the recommended service corresponding thereto as the type information. Even in this case, it is also possible to accept the input of the desired operation time indicated in the table c.

In the table b, the operation location information is the facility size of the facility in which the robot is introduced. The input person selects and inputs, for example, whether the facility scale is a large facility on a plurality of floors, a large facility on a single floor, or a store on a single floor of one store on a plurality of floors. In the example of the table b, for example, when the facility scale is a large facility (a plurality of floors), facility information indicating facilities such as an elevator and a door is shown in UI images, and the input person can select the facility scale while confirming the facility scale, and the selected facility scale is input as the operation location information. Alternatively, for example, when the input person selects a large facility (a plurality of floors) as the facility scale, the large facility (a plurality of floors) is input as the operation location information. Selection of facility information such as number and size of elevators and doors is also accepted. The facility information is also input as the operation location information. Depending on the size of the elevator or door, the size of the mobile robot 20 recommended at the time of output is limited. As described above, when the selection input of the facility size is performed, the input processing unit 11a can input the facility size as the operation location information, or can also input the facility information corresponding to the facility size as the operation location information. The input person may input both the facility type and the facility scale as the operation location information. In other words, the input person may input the operation location data from both of the tables a, b. In addition, the operation location information may include, for example, a floor map to be used in operation as the floor map 221.

In the table c, the type information is a service type indicating the type of the service executed in the facility. For example, as the type information, the input person selects and inputs one or a plurality of services to be executed in the setting from among conveyance, table setting, lower table, cleaning, and guidance of a person. The type information may include detailed information about the executable service content. For example, the cleaning service may be distinguished by information indicating whether the floor surface to be cleaned is a carpet, a tile, or both. Further, the transportation service may be distinguished by information indicating a transportable conveyed object. More specifically, the type information may include information indicating which of a plurality of types of conveyed items, such as a medicine, a medical record, a linen, and a patient, among the conveyed items among the conveyed services. The medical article may include a specimen, or the specimen may be handled as a transported article separate from the medical article. In addition, there may be a unit in which the type of the transport unit 31 can accommodate the conveyed object and lock the conveyed object, and a unit in which the type of the conveyance unit is not. In this case, the type information may include information indicating whether the transportation service is a service for transporting an important transportation object such as a medicine or a medical record or a service for transporting another transportation object as a transportation service. Further, the type information may include information selected from a plurality of different services depending on the weight and size of the transportable object as the transportation service. Further, the type of the transport unit 31 may be a wheelchair-type robot or a stretcher-type robot that transports a patient. In this case, the type information may include information indicating whether the transportation service is a service for transporting a patient or a service for transporting another transported object as a transportation service.

Further, the input person inputs a desired operation time of the service, that is, an execution time, such as a time period in which operation is desired, for example, from 10:00 to 21:00, a period in which operation is desired, for example, for 5 years. The desired operating time may include information about the operating time, operating area, operating range, and operating speed at which the mobile robot 20 and accessory unit 30 perform the service. For example, the desired operating time may include information regarding the cleaning area per hour, the security area, the guidance distance, or the transport distance. Alternatively, the movable range may include information about the width of the passage, information indicating whether or not the vehicle is movable by the elevator, or information indicating whether or not the vehicle can be used outdoors. Note that the operation area and the operation range may be included in the operation location information instead of the type information.

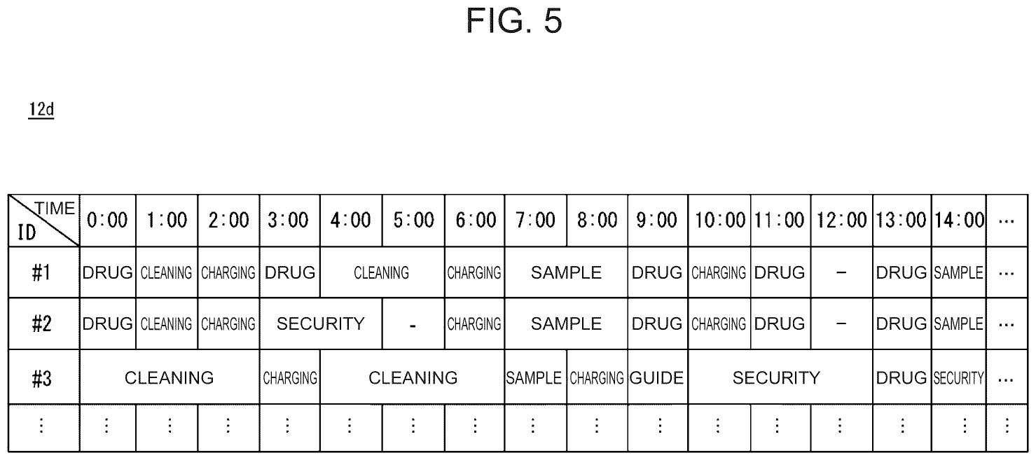

The calculation processing unit 11b calculates scheduling information based on the input information such that the time zone is included in the desired operation time thus input. This scheduling information is generated so as to include the operational shifts of the mobile robots 20 and the accessory units 30 as in the table 12d shown in FIG. 5, for example, and can be referred to when the resource information is calculated. The operation shift can be calculated based on the above-described input information, for example, taking into consideration predetermined constraints such as the continuous operation time of each mobile robot 20, the time required for charging, and the number of devices that can be prepared excluding the devices during charging or maintenance. This constraint condition may be included in the unit information and input. The table 12d was calculated based on the following unit data. Both the #1 and #2 mobile robots can perform cleaning services and transport services for specimens and chemicals. Neither of these robots can support transport services such as linen and people. The #3 mobile robot can perform cleaning services, guidance services, security services, and sample, drug, and patient (human) transport services. In the table 12d, charging indicates that the mobile robots are stopping at the charging station, charging the battery, and not performing servicing. As described above, the time zone information may include information about a time zone in which the mobile robot 20 is charged.

The calculation processing unit 11b performs calculation processing for calculating, based on the scheduling information, resource information that is information related to resource amounts of the mobile robot 20 and the plurality of accessory units 30 required for the service. Although the calculation method is not limited, the calculation processing unit 11b selects the type and the number of the recommended mobile robots 20 and the accessory units 30 corresponding to the services indicated by the inputted unit information on the basis of the calculated scheduling information. The calculated resource information may include, for example, the required number and type of the mobile robot 20 and the accessory unit 30, and may include the total amount thereof. Therefore, in the operation stage, additional necessary resource information may be calculated by subtracting the type and number of devices such as the mobile robot 20 and the accessory unit 30 in operation indicated by the unit information. Further, the resource amount may include a resource amount for another device such as a server device such as the management device 10 necessary for management of the mobile robot 20 and the accessory unit 30. The resource amount may include a resource amount indicating the number of persons or a total number of persons necessary for using the mobile robot 20 or the accessory unit 30, requirements such as a skill required for the persons, a necessary training period, a necessary type of training, a necessary personnel cost, and the like. That is, the calculation process may calculate information including information on the amount of resources of a necessary person on the basis of the schedule information as part of the resource information. Further, the calculation process may calculate resource information for each of a plurality of combinations of the mobile robot 20 and the accessory unit 30 required for the service based on the schedule information. That is, the calculation process may calculate not only resource information of one pattern but also resource information of a plurality of patterns, that is, information indicating a plan of a plurality of combinations.

The total amount may include an introduction cost such as an initial cost and an operation cost such as a running cost including a maintenance cost, and the operation cost may include a personnel cost. Further, the total amount may be a monthly cost such as a subscription by rental or the like or a yearly cost. When the desired operation time is input as the type information, the total amount may be an expense corresponding to the desired operation time. The total amount may include an installation cost for each mobile robot 20 or for each accessory unit 30. Further, the calculation processing unit 11b may calculate information indicating a service that can be provided by the mobile robot 20 alone without the accessory unit 30 by including the information in the resource information, for example, when the mobile robot 20 is a transfer robot A having a lockable storage unit.

The output processing unit 11c outputs the calculation result in the calculation processing as an output destination of a designated device such as the user terminal 400, an external server device (not shown), or a printing device (not shown). The outcome includes the type and number of recommended mobile robots 20 and the type and number of recommended accessory units 30, for example, the table 12c shown in FIG. 4. The output result may include at least one of a purchase amount and a rental amount when the recommended device is introduced as an estimate. The output result may include detailed information about the executable service content. For example, in a case where the mobile robot 20 is a robot capable of supporting conveyance and the accessory unit 30 is a wagon unit, the detailed information may include information indicating a conveyable object. For example, in a case where there are a plurality of types of transported items, such as a medicine, a medical record, and a linen, the detailed information may include information indicating whether or not each transported item is transportable. The detailed information may include information on the weight and size of the transportable object. For example, since the transfer robot A can lock the storage portion of the conveyed object, it transports important conveyed objects such as medicines and medical records. The transfer robot B is a wheelchair-type robot or a stretcher-type robot that conveys a patient. The wagon unit A is an accessory unit for carrying linen. The wagon unit B is an accessory unit for transporting corrugated cardboard, fixtures, and the like. The detailed information may include such information. The detailed information may include information about the cleanable floor surface, such as, for example, information indicating that the cleaning unit A is a unit for carpet cleaning and the cleaning unit B is a unit for tile cleaning.

Further, the calculation processing unit 11b may use a first machine learning model for inputting the type information and the operation location information and outputting the schedule information in calculating the resource information, and a second machine learning model for inputting the schedule information and outputting the output information. Any machine learning model can use a model such as deep learning, but the algorithm is not limited. The first machine learning model may be a model in which a data set including correct answer data of the type information, the operation location information, the various types of information, and the schedule information on the operation location information is machine-learned. The second machine learning model may be a model in which a data set including correct answer data of the schedule information and the output information for each schedule information is machine-learned. In addition, the calculation processing unit 11b may calculate the resource-information using only the second machine-learning model. In this case, the schedule information may be created by the input person or may be generated by another method that does not use a model such as the first machine learning model. In addition, the operation location information may include, for example, a floor map to be used in operation as the floor map 221. In such cases, the calculation processing unit 11b may use a machine-learning model suitable for image-recognition such as CNN (Convolutional Neural Network).

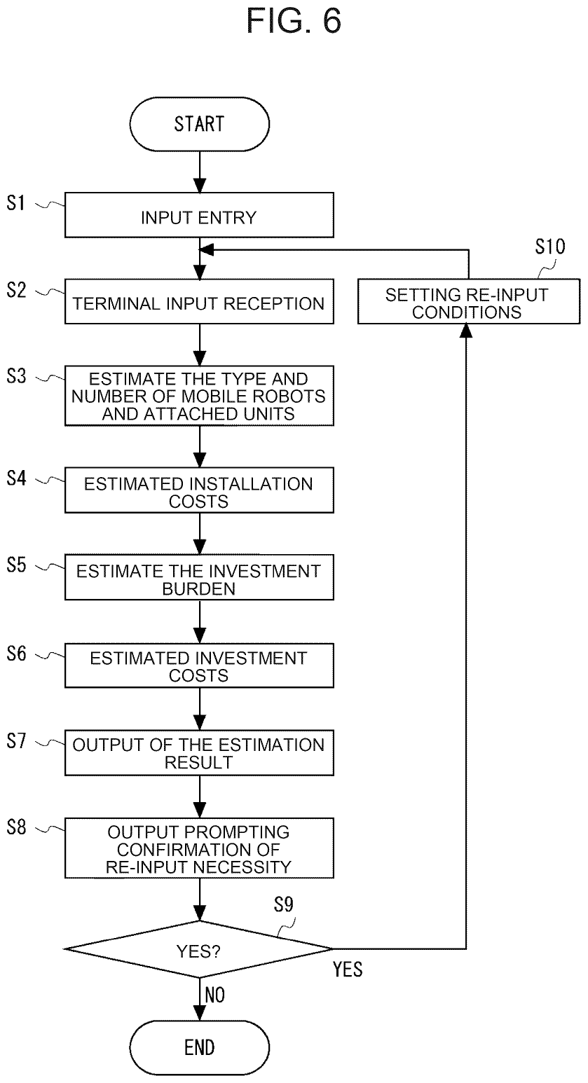

An example of an information providing method will be described with reference to FIG. 6. First, the input processing unit 11a receives an instruction from the user terminal 400 to start processing, and inputs unit data such as a DB 12b (S1). Next, the input processing unit 11a causes the user terminal 400 to display UI images for inputting the time zone information and the type information, and accepts the input of the time zone information and the type information from the input person at the user terminal 400 (S2). Then, the calculation processing unit 11b calculates the types and the numbers of the mobile robots 20 and the accessory units 30 required as the resource information based on the input information, thereby performing these estimations (S3). The calculation processing unit 11b estimates the cost of purchasing or renting according to the estimation (S4). The calculation processing unit 11b estimates the cost burden required for the operation based on the estimation result (S5), and estimates the operation cost that is the running cost (S6). The output processing unit 11c outputs the estimation results to the user terminal 400 (S7). In addition, the output processing unit 11c outputs, to the user terminal 400, UI images prompting the necessity of re-inputting the time-zone information and the type information together with the result of the estimation or after outputting the result (S8). The output processing unit 11c determines whether or not there is an answer to S8 (S9), and ends the processing if there is no answer. If a S9 answer is received, the input processing unit 11a sets the re-input condition (S10). In S10, candidates for re-input items in time zone information and type information, such as a desired operation time, are set in advance, and re-input conditions are set by generating or reading UI images that cause the user terminal 400 to input information about each of the candidates. After S10, proceed to S2 process. After S10, the process may proceed to S1 process and resume from the designation of the unit data, or the process of S10 may be omitted and the process may proceed to S2 or S1 process.

As described above, the information providing system is capable of calculating and outputting necessary information of the mobile robot and the attached unit in accordance with the time constraint of the traveling environment of the mobile robot. Therefore, according to the present embodiment, it is possible to quantitatively indicate necessary robot-related resources corresponding to the task time and the shift to the input person as the user, and thus it is possible to realize a system that assists the determination of the introduction of the robot and the decision of the use determination for a certain period of time. In addition, some or all of the processing in the management device 10, the mobile robot 20, the user terminal 400, and the like can be realized as a computer program. The program includes instructions (or software code) that, when loaded into a computer, cause the computer to perform one or more of the functions described in the embodiments. The program may be stored in a non-transitory computer-readable medium or a tangible storage medium. The program may be transmitted on a transitory computer readable medium or a communication medium, such as an electrical, optical, acoustic, or other form of propagated signal. The present disclosure is not limited to the above embodiments, and can be appropriately modified without departing from the spirit.

What is claimed is:

1. An information providing system that provides information about an autonomous mobile robot, the information providing system being configured to
input input information including information regarding a plurality of robot accessory units that enable the autonomous mobile robot to execute a plurality of different services by being used in combination with the autonomous mobile robot, information regarding a time period in which the autonomous mobile robot operates, and information regarding a type of a required service,
perform calculation processing of calculating resource information that is information regarding an amount of resources for the autonomous mobile robot and the plurality of robot accessory units required for a service based on the input information, and
output a result of calculation in the calculation processing.

2. The information providing system according to claim 1, wherein the information regarding the time period and the information regarding the type are schedule information in which the time period is stored for each type of the required service.

3. The information providing system according to claim 1, wherein the information regarding the time period includes information regarding a time period in which the autonomous mobile robot is charged.

4. The information providing system according to claim 1, wherein in the calculation processing, information including information regarding an amount of required human resources is calculated as a part of the resource information based on the input information.

5. An information providing method by which a computer provides information about an autonomous mobile robot, the method comprising:
inputting input information including information regarding a plurality of robot accessory units that enable the autonomous mobile robot to execute a plurality of different services by being used in combination with the autonomous mobile robot, information regarding a time period in which the autonomous mobile robot operates, and information regarding a type of a required service,
performing calculation processing of calculating resource information that is information regarding an amount of resources for the autonomous mobile robot and the plurality of robot accessory units required for a service based on the input information, and
outputting a result of calculation in the calculation processing.
